(19) United States
(12) Patent Application Publication
(10) Pub. No.: US 2012/0316679 A1
(43) Pub. Date: Dec. 13, 2012

(54) PROVIDING REMOTE GESTURAL AND VOICE INPUT TO A MOBILE ROBOT

(75) Inventors: Efstathios Papaefstathiou, Redmond, WA (US); Russell Sanchez, Redmond, WA (US); Nathaniel T. Clinton, Sammamish, WA (US)

(73) Assignee: Microsoft Corporation, Redmond, WA (US)

(21) Appl. No.: 13/154,468

(22) Filed: Jun. 7, 2011

(51) Int. Cl. B25J 13/08

(52) U.S. Cl. 700/258; 901/1

(57) ABSTRACT

A system, such as a robot, which responds to voice, gesture and other natural inputs from a user, is controllable when the user is out of range through use of a wireless controller. The wireless controller provides inputs that allow the user to enter commands that are a proxy for the voice and gesture inputs the robot otherwise recognizes. The controller can include, for example, a microphone for voice input, a pad for directional control, and a speaker and display devices to provide responses from the robot.

### BACKGROUND

Robots and other systems, such as game controllers, have been designed to respond to both sound and visual inputs. Providing this kind of control enables users to interact with the system without using a hand held input device.

However, there are situations when the sound and/or visual inputs cannot be processed, and thus the system cannot be controlled by sound and/or gestures. For example, the environment may be noisy such that the voice of the user cannot be sensed by the robot. Or, the line of sight between the robot camera and the user may be obstructed. The user may be too far away to be seen or heard by the robot.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

A system, such as a robot, which responds to voice, gesture and other natural inputs from a user, is controllable when the user is out of range through use of a wireless controller. The wireless controller provides inputs that allow the user to enter commands that are a proxy for the voice and gesture inputs the robot otherwise recognizes. The controller can include, for example, a microphone for voice input, a pad for directional control, and a speaker and display devices to provide responses from the robot.

Accordingly, in one aspect a robot system includes a robot with a plurality of sensors for detecting actions of a user and providing sensory data as outputs. A sensory input processing system has an input for receiving the sensory data and an output providing commands generated from the sensory data. A control system is responsive to the commands to control operations of the robot, and outputs feedback to the user. A remote device is in wireless communication with the robot, and provides at least a portion of the sensory data as inputs to the robot. At least a portion of the commands available to the robot can be provided by the remote device. The remote device also has outputs that provide at least a portion of the feedback from the robot to the user.

In another aspect, a robot with a plurality of sensors for detecting actions of a user and providing sensory data as outputs. A sensory input processing system has an input for receiving the sensory data and an output providing commands generated from the sensory data. A control system is responsive to the commands to control operations of the robot, and outputs feedback to the user. The robot has a wireless input that receives data from the remote device. The data from the remote device is at least a subset of the sensory data and commands. The robot sends feedback to the remote device that includes at least a subset of feedback provided on the robot. In one implementation, less than the full set of sensory data, commands and/or feedback is provided. In another implementation, the full set of sensory data, commands and feedback is provided.

In another aspect, a remote device for wireless connection to a robot includes input devices for receiving inputs from a user. Information about user activity is transmitted to the robot. The user activity is translated into commands which are at least a subset of commands performed by the robot. The commands performed by the robot are generated in response to processing sensory data obtained by sensing actions of the user. The robot provides feedback about performance of commands to the remote device in response to the user activity. The feedback is displayed on the remote device.

In the following description, reference is made to the accompanying drawings which form a part hereof, and in which are shown, by way of illustration, specific example implementations of this technique. It is understood that other embodiments may be utilized and structural changes may be made without departing from the scope of the disclosure.

### DESCRIPTION OF THE DRAWINGS

FIG. 1 is a block diagram of a robotic system that responds to natural input such as speech and gestures of an individual with a remote device.

FIG. 2 is a block diagram illustrating an example implementation of a remote device.

FIG. 3 is a more flow chart illustrating how the remote device and robot connect.

FIG. 4 is a flow chart describing how commands from the remote device are processed.

FIG. 5 is a block diagram of an example computing device in which such a system can be implemented.

### DETAILED DESCRIPTION

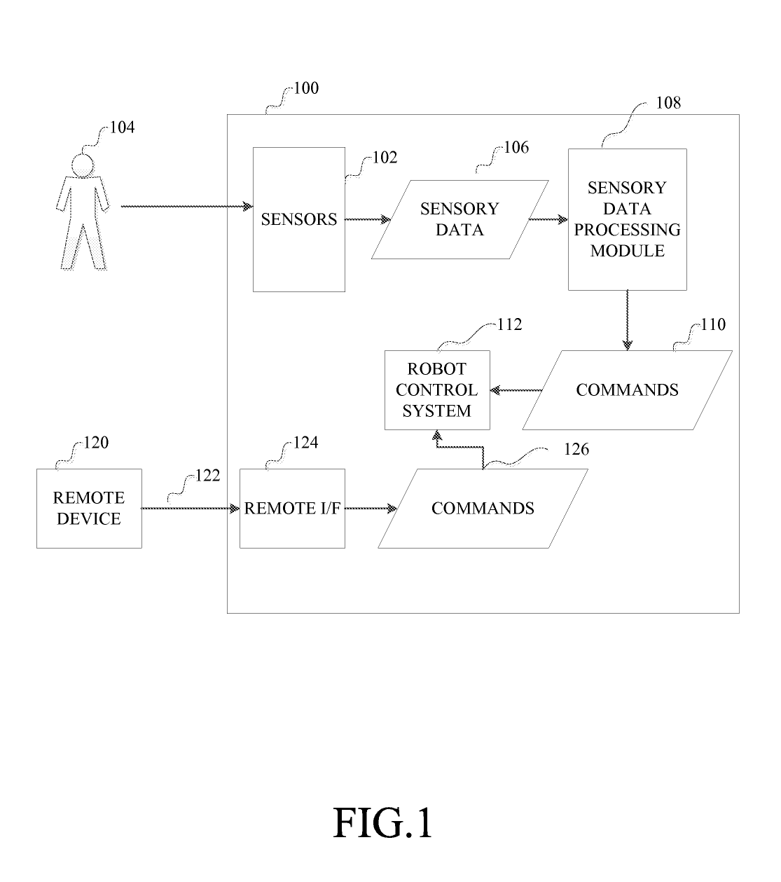

Referring to FIG. 1, a mobile robot 100 includes a variety of sensors 102. Sensors 102 detect information about the surrounding environment, such as an individual 104 in that environment. The sensors 102 provide sensory data 106 as input to the rest of the robot's systems. Example sensors include, but are not limited to, one or more video cameras, one or more microphones, such as a microphone array, infrared detectors, and proximity detectors. The invention is not limited to a particular set of or arrangement of sensors 102, so long as the sensory data 106 provided by the sensors enables a user to provide meaningful input to the robot.

A sensory data processing module 108 processes the sensory data 106 to provide commands 110 to the robot control system 112. The sensory data processing module can perform a variety of operations, such as speech recognition and gesture recognition and other kinds of recognition that enable commands from the individual 104 to be recognized. The robot control system 112 can perform a variety of operations, such as navigation and obstacle avoidance, object recognition, task performance and the like. The invention is not limited to any particular robot control system 112.

In its normal operation, the robot responds to gestures and voice from the individual as recognized through the sensors and sensory input processing module. These kinds of controls work when the sensors are capable of capturing sound and images of sufficient quality to recognize speech and gestures. In some cases, for example, if the environment is noisy, or if the individual is too far away or too close, or if the individual is obscured in some way, the robot cannot discern the commands given by the individual.

A remote device 120 can be used as a proxy to communication that would occur directly between individual and robot if they were otherwise close to each other or were not in a noisy environment. In one implementation, the device is equipped with at least a subset of the robot's sensory and feedback capabilities, such as a speaker, microphone, buttons, camera, lights and display, can be used to extend robotic natural user interfaces.

A remote device 120 communicates with the robot 100 through a wireless connection 122. Signals from the remote device 120 are received at the robot through a remote interface 124. The remote interface processes the signals from the remote device to provide commands 126. The commands 126 are a proxy for, and at least a subset of, the commands 110. Similarly, signals from the robot 100 are transmitted to the remote device 120 through the remote interface 124, such as a wireless transceiver. Such signals contain at least status information about the robot 100. The remote device processes these signals to convey to the individual any status information about the robot 100.

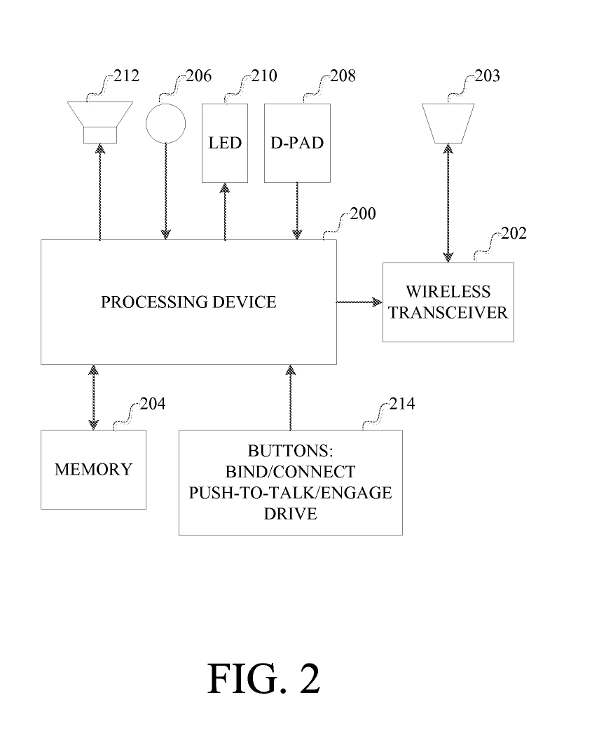

Given this context, an example implementation of the remote device 120 will be described in more detail in connection with FIGS. 2-4.

In FIG. 2, a block diagram of an example implementation of the remote device 120 of FIG. 1 will now be described. A processing device 200 is connected to a wireless transceiver 202, connected to an antenna 203. A memory 204, such as a flash memory, stores instructions that are executed by the processing device 200. Inputs include a microphone 206 and a “D-Pad” 208, which provides a 4 way directional button input and a select button. Outputs include one or more LEDs 210 and a speaker 212. Additional buttons 214 also are provided. These additional buttons can include, but are not limited to, a connect button, a push-to-talk button and a drive button. Volume controls also can be provided. Such a circuit also has a source of a clock signal and a source of power, such as a battery.

While the configuration of the various inputs and outputs is not limiting of the present invention, a useful configuration is one used in a controller of the XBOX® video game system available from Microsoft Corporation.

Some example commands from a natural, direct interface that can be mimicked by this remote device are as follows. Using speech, for example, the user may identify the robot, such as by calling out a name for the robot, then provide a spoken command. Using the remote device, the user presses the “push to talk” button, and then speaks a command.

In the natural interface, the user can gesture with a hand motion, for example, up, down, left or right, in response to which the robot moves in the indicated direction. On the remote device, the user presses buttons, such as the d-pad, to indicate navigational direction.

Similarly, if the natural interface detects other gestures, such as a motion that would allow selection of items, the select button can be pressed on the remote device to indicate a selection.

For feedback from the robot, the robot may play back audio through its speakers or display expression through clusters of LEDs or a display on the robot. If the robot detects the remote device as active, then the robot can send audio and display data for output on the speakers and displays of the remote device.

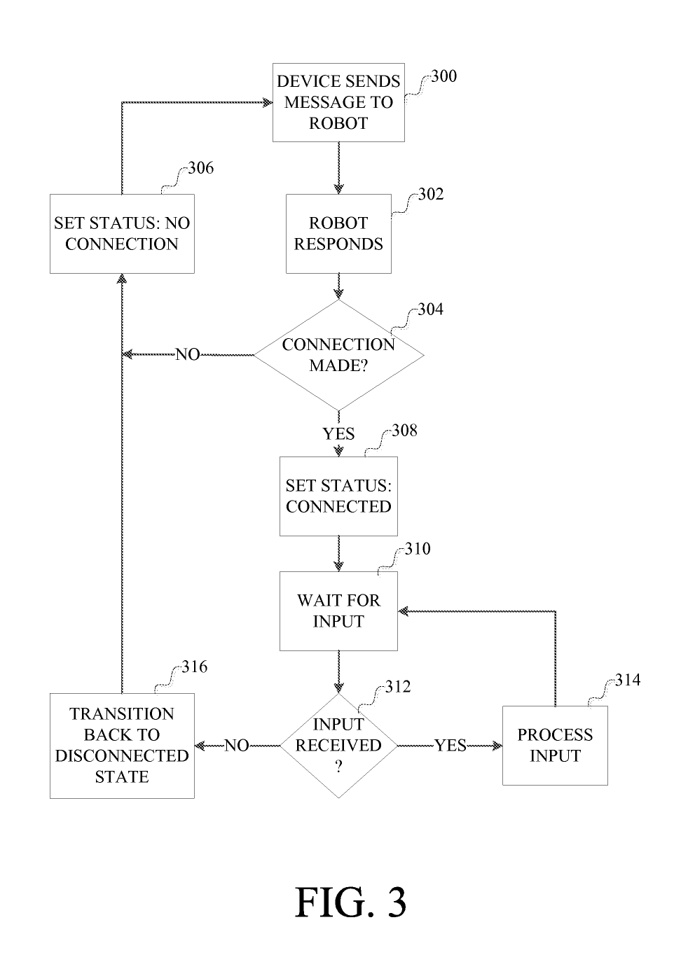

Operation of the remote device and the robot will now be described in connection with the flow chart of FIG. 3.

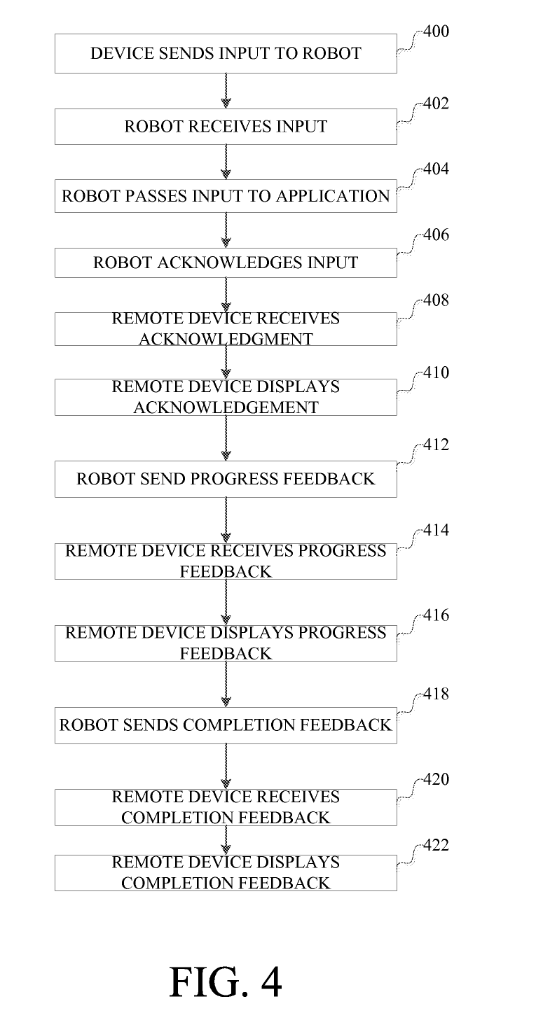

Initially, the user instructs the remote device to connect with the robot, for example by pushing a connect button, in response to which the remote device sends 300 a message to the robot. The robot responds 302 if it can make the connection. If the robot responds that a connection is made, as determined in 304, then an LED can be set 306 to indicate a connection or set 308 to indicate there is no connection. If connected, the device waits 310 for further input. After some time if no input is received, the device can transition 312 back to a disconnected state. If an input is received 314, then that input is processed. Input processing will be described in connection with FIG. 4.

In FIG. 4, in response to receiving user input, the device sends 400 the input to the robot. The robot receives 402 the input, and then passes 404 the input to the appropriate application running on the robot.

Depending on the task being performed by the robot, the robot can acknowledge 406 the input, for example by sending audio data. The remote device receives 408 the acknowledgement and displays 410 information about the acknowledgement to the user. For example, the status of LEDs can change, or audio can be played back on the speakers.

As a task progresses on the robot, the robot can send 412 progress feedback. The remote device receives 414 the progress feedback and displays 416 information about the progress feedback to the user. For example, the status of LEDs can change, or audio can be played back on the speakers.

Similarly, when a task completes on the robot, the robot can send 418 progress feedback. The remote device receives 420 the completion feedback and displays 422 information about the completion feedback to the user. For example, the status of LEDs can change, or audio can be played back on the speakers.

Regarding specific operations, if the input received at 400 is the push to talk button, followed by audio, then the remote device records audio data and send the audio data to the robot. The robot receives the audio data and acknowledges and acts on the command as if the command was received through its own microphone(s). The robot can ignore other audio input that it otherwise receives through its own microphone(s). Any audio output by the robot can be directed to the remote device for playback on the remote device speakers.

As another example, the D-pad can be used to navigate and select items on a display for the robot For example, if the robot has displayed items on its own display, one of them (such as the center one), is indicated as a current selection, or the active item. In response to inputs from the D-pad, several operations occur. In response to a user pressing a button, the remote device sends an indication to the robot that the button was pushed. If the button is the select button, then the robot interprets this as a selection of the active item. Pressing the select button again is interpreted as a deselection of the active item. The other buttons on the D-pad (left, right, up and down), change the active item. Some feedback from the robot to the remote device provides information to the user about the active item. Given a selected active item, other verbal commands and other inputs can be received through the remote device.

Another example operation is driving the motors on the robot. If the robot is engaged with the remote device, and the user presses and holds the ‘drive’ button on the remote device, an indication that this button is pressed is sent to the robot. Processing this input causes a command to the robot's motion control system to be sent, instructing the robot to move forward. The robot's navigation control system can provide for avoiding obstacles. While the drive button is held and the robot is moving, the user can control the robot's direction of motion using the D-pad. When the user releases the drive button, an indication that this button is released is sent to the robot. Processing this input causes a command to be sent to the motion control system instructing the robot to stop moving. If the drive button is pressed, then if other buttons are pressed, the indications of these other buttons are sent to the robot. The left button would cause an instruction to move left, and the right button would cause an instruction to move right. The down button causes an instruction to move slowly in reverse. It is possible to interpret these buttons on the remote device and send appropriate commands to the robot, or to interpret these button actions on the robot to provide the desired command.

Having now described an example implementation, a computing environment in which such a system is designed to operate will now be described. The following description is intended to provide a brief, general description of a suitable computing environment in which this system can be implemented. The system can be implemented with numerous general purpose or special purpose computing hardware configurations. A mobile robot typically has computing power similar to other well known computing devices such as personal computers, hand-held or laptop devices (for example, media players, notebook computers, cellular phones, personal data assistants, voice recorders), multiprocessor systems, microprocessor-based systems, set top boxes, game consoles, programmable consumer electronics, and the like. Because the control system for the robot also may be on a computer separate and/or remote from the robot, other computing machines can be used to implement the robotic system described herein.

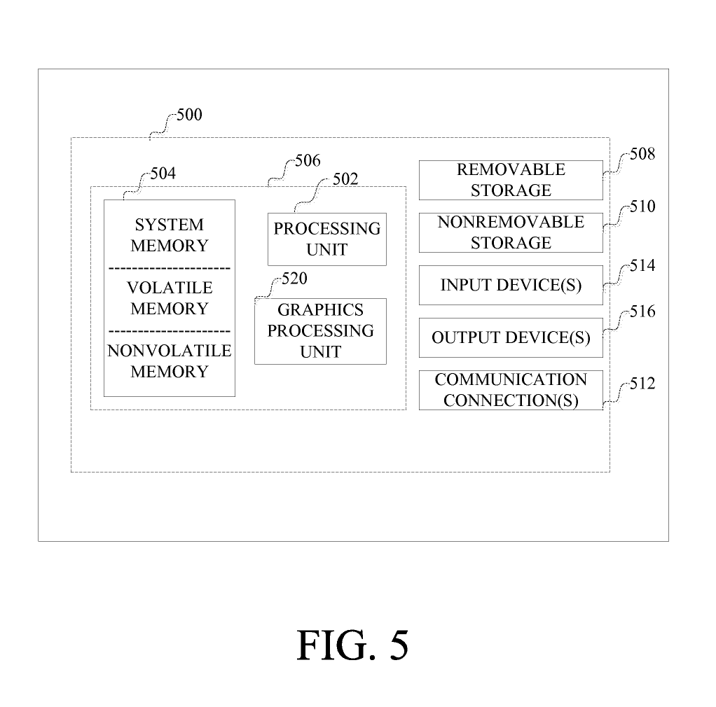

FIG. 5 illustrates an example of a suitable computing system environment. The computing system environment is only one example of a suitable computing environment and is not intended to suggest any limitation as to the scope of use or functionality of such a computing environment. Neither should the computing environment be interpreted as having any dependency or requirement relating to any one or combination of components illustrated in the example operating environment.

With reference to FIG. 5, an example computing environment includes a computing machine, such as computing machine 500. In its most basic configuration, computing machine 500 typically includes at least one processing unit 502 and memory 504. The computing device may include multiple processing units and/or additional co-processing units such as graphics processing unit 520. Depending on the exact configuration and type of computing device, memory 504 may be volatile (such as RAM), non-volatile (such as ROM, flash memory, etc.) or some combination of the two. This most basic configuration is illustrated in FIG. 5 by dashed line 506. Additionally, computing machine 500 may also have additional features/functionality. For example, computing machine 500 may also include additional storage (removable and/or non-removable) including, but not limited to, magnetic or optical disks or tape. Such additional storage is illustrated in FIG. 5 by removable storage 508 and non-removable storage 510. Computer storage media includes volatile and nonvolatile, removable and non-removable media implemented in any method or technology for storage of information such as computer program instructions, data structures, program modules or other data. Memory 504, removable storage 508 and non-removable storage 510 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by computing machine 500. Any such computer storage media may be part of computing machine 500.

Computing machine 500 may also contain communications connection(s) 512 that allow the device to communicate with other devices. Communications connection(s) 512 is an example of communication media. Communication media typically carries computer program instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal, thereby changing the configuration or state of the receiving device of the signal. By way of example, and not limitation, communication media includes wired media such as a wired network or direct-wired connection, and wireless media such as acoustic, RF, infrared and other wireless media.

Computing machine 500 may have various input device(s) 514 such as a display, a keyboard, mouse, pen, camera, touch input device, and so on. Output device(s) 516 such as speakers, a printer, and so on may also be included. All of these devices are well known in the art and need not be discussed at length here.

Such a system may be implemented in the general context of software, including computer-executable instructions and/or computer-interpreted instructions, such as program modules, being processed by a computing machine. Generally, program modules include routines, programs, objects, components, data structures, and so on, that, when processed by a processing unit, instruct the processing unit to perform particular tasks or implement particular abstract data types. This system may be practiced in distributed computing environments where tasks are performed by remote processing devices that are linked through a communications network. In a distributed computing environment, program modules may be located in both local and remote computer storage media including memory storage devices.

The terms “article of manufacture”, “process”, “machine” and “composition of matter” in the preambles of the appended claims are intended to limit the claims to subject matter deemed to fall within the scope of patentable subject matter defined by the use of these terms in 35 U.S.C. §101.

Any or all of the aforementioned alternate embodiments described herein may be used in any combination desired to form additional hybrid embodiments. It should be understood that the subject matter defined in the appended claims is not necessarily limited to the specific implementations described above. The specific implementations described above are disclosed as examples only.

What is claimed is:

1. A robot system, comprising:
a robot having a plurality of sensors for detecting actions of a user and providing sensory data as outputs, and a sensory input processing system having an input for receiving the sensory data and an output providing commands generated from the sensory data, and a control system responsive to the commands to control operations of the robot, and outputs providing feedback to the user;
a remote device in wireless communication with the robot, and providing at least a portion of the commands to the robot, and having outputs for providing at least a portion of the feedback from the robot to the user.

2. The robot system of claim 1, wherein the commands include commands derived from speech recognition, and wherein the sensory data provided by the remote device includes audio data.

3. The robot system of claim 1, wherein the feedback includes audio data, and the remote device outputs the audio data.

4. The robot system of claim 1, wherein the commands include directional commands derived from gesture recognition applied to the sensory data, and the inputs from the remote device include information indicating whether user presses one or more buttons, and the inputs are processed as the commands derived from gesture recognition.

5. The robot system of claim 1, wherein in response to an indication of a direction from the remote device, the robot system starts moving in the indicated direction while avoiding obstacles.

6. A robot comprising:
a plurality of sensors for detecting actions of a user and providing sensory data as outputs;
a sensory input processing system having an input for receiving the sensory data and an output providing commands generated from the sensory data;
a control system responsive to the commands to control operations of the robot;
outputs providing feedback to the user;
a wireless input that receives data from a remote device, wherein the data from the remote device is at least a subset of the sensory data and commands, and wherein the robot sends feedback to the remote device that includes at least a subset of feedback provided on the robot.

7. The robot of claim 6, wherein the commands include commands derived from speech recognition, and wherein the sensory data provided by the remote device includes audio data.

8. The robot of claim 6, wherein the feedback includes audio data, and the remote device outputs the audio data.

9. The robot of claim 6, wherein the commands include directional commands derived from gesture recognition applied to the sensory data, and the inputs from the remote device include information indicating whether user presses one or more buttons, and the inputs are processed as the commands derived from gesture recognition.

10. The robot of claim 6, wherein in response to an indication of a direction from the remote device, the robot starts moving in the indicated direction while avoiding obstacles.

11. A device for a wireless connection to a robot, comprising:
input devices for receiving inputs from a user;
a wireless transceiver for transmitting information about the user inputs to the robot,
such that the user inputs are translated into commands which are at least a subset of commands performed by the robot generated in response to processing sensory data obtained by sensing actions of the user; and
the wireless transceiver receiving feedback about performance of commands from the robot;
display devices for displaying the feedback from the robot.

12. The device of claim 11, wherein the commands include commands derived from speech recognition, and wherein the sensory data provided by the remote device includes audio data.

13. The device of claim 11, wherein the feedback includes audio data, and the remote device outputs the audio data.

14. The device of claim 11, wherein the commands include directional commands derived from gesture recognition applied to the sensory data, and the inputs from the remote device include information indicating whether user presses one or more buttons, and the inputs are processed as the commands derived from gesture recognition.

15. The robot of claim 11, wherein in response to an indication of a direction from the remote device, the robot starts moving in the indicated direction while avoiding obstacles.

16. A process for controlling a robot, comprising;
receiving data from a mobile device remote from the robot, wherein the data includes user input;
deriving commands from the user input, wherein the commands include at least a subset of commands that the robot derives from processing sensory data on the robot in response to a user;
generating feedback to the remote device about the command; and
causing the remote device to display the feedback to a user.

17. The process of claim 16, wherein the commands include commands derived from speech recognition, and wherein the sensory data provided by the remote device includes audio data.

18. The process of claim 16, wherein the feedback includes audio data, and the remote device outputs the audio data.

19. The process of claim 16, wherein the commands include directional commands derived from gesture recognition applied to the sensory data, and the inputs from the remote device include information indicating whether user presses one or more buttons, and the inputs are processed as the commands derived from gesture recognition.

20. The process of claim 16, wherein in response to an indication of a direction from the remote device, the robot starts moving in the indicated direction while avoiding obstacles.
